(19) United States
(12) Patent Application Publication
(10) Pub. No.: US 2012/0028001 A1
(43) Pub. Date: Feb. 2, 2012

(54) Thermoformed or Molded Partition

(75) Inventors: Hilary Farnsworth, Mamoronek, NY (US); David Daiute, Drums, PA (US); Stew Mitchell, Old Forge, PA (US)

(73) Assignee: SCRANTON PRODUCTS INC., Scranton, PA (US)

(21) Appl. No.: 12/845,074

(22) Filed: Jul. 28, 2010

(51) Int. Cl. B32B 3/00; B29C 37/02; B29C 69/00

(52) U.S. Cl. 428/178; 264/241; 264/161

(57) ABSTRACT

A partition panel is made of two overlaying sheets of high density polyethylene or other plastic material which have been bonded together around a perimeter and at selected regions such that the partition panel contains bonded regions where the two sheets are bonded together and hollow regions where the two sheets are spaced apart from one another. The partition panel is preferably made by thermoforming.

### FIELD OF INVENTION

The invention relates to partitions that are used to define and separate areas such as bathroom stalls and provide privacy.

### BACKGROUND OF THE INVENTION

Five major types of panel constructions are currently in wide use for bathroom partitions. These are typically categorized by the material used for the door and side panels and include metal with a baked enamel finish, stainless steel, plastic laminate, solid phenolic and solid plastic.

The baked enamel metal panel constructions consist of 20 to 22 gauge galvanized steel wall panels and door panels with a honeycomb core. The core is glued to the metal skins and the edges are covered with a locking cap molding. The finish of these panels is baked on enamel. The advantage of this type of panel construction is its low cost. However, it is very susceptible to rusting, corrosion and vandalism. In addition, the finish can be scratched easily and the metal can be dented. Painted or powder coated panels have been used in place of baked enamel panels. But these panels have the same disadvantages.

Stainless steel panels have a construction similar to that of baked enamel panels with the exception that stainless steel sheets are used in place of the galvanized steel. This provides some advantages, but also increases the cost of the panel construction. Like baked enamel panel constructions, stainless steel panel constructions are susceptible to denting. Moreover, there are several commercial cleaning solutions that will cause the stainless steel to corrode.

The internal core used in metal partitions is typically made of corrugated cardboard. Moisture can enter these panels and degrade the cardboard as well as cause corrosion of the metal. This moisture also creates an unsanitary condition. Moisture is trapped in the interior of the panel and that interior cannot be accessed for cleaning.

Plastic does not corrode or absorb moisture. Scratches are less noticeable on plastic and can often be removed or filled. Patterns may be embossed upon plastic panels that make scratches less noticeable and make it difficult to mar or mark the panels with graffiti. Denting is also less of a problem with plastic panels because plastic panels can be made from plastics that absorb more force than metal components.

The plastic laminate panel constructions are made from 0.050 thick plastic laminate similar to FORMICA® plastic laminate. This laminate is applied to a core of particle board across both faces as well as the edges. In a high moisture environment the cores will expand and cause the laminate to come loose from the core. Although the surface is harder-than the baked enamel, once it is scratched there is no way to fix it short of replacing the entire panel.

Solid core phenolic panel constructions are typically constructed from a compression molded phenolic core with a melamine surface. This panel is a piece of plastic laminate that is anywhere from ½″ to 1″ thick with a decorative laminate on both sides. The wall and door panels are constructed of a single piece of material. Any damage to the panel requires its complete replacement.

The solid plastic panel constructions now in use have door and side panels made of single sheets of compression molded high density polyethylene (H.D.P.E.). These door and wall sized panels are quite large. The size of these panels impose practical limits on the methods which can be used to form the panels; while compression molding is acceptable, extrusion or pultrusion are more costly and therefore may be unacceptable. This in turn limits the types of material which can be used.

The many advantages of plastic partitions known in the art can be offset by the cost in labor, time and materials used to make them. Many of the larger plastic panels can be quite heavy such that at least two people are needed to install these partitions.

There remains a need for bathroom partitions which are lightweight, are easy to install and clean, are relatively graffiti proof and are inexpensive to manufacture.

### SUMMARY OF THE INVENTION

We provide a partition that is preferably thermoformed from two sheets of plastic, preferably high density polyethylene. One preferred fabrication method is twin sheet thermoforming. The two sheets are heated and placed between a pair of thermoforming molds or dies. The molds are configured such that the partition formed from the two sheets will have regions where the sheets are spaced apart from one another and regions where the sheets abut one another such that the abutting surfaces are bonded together. These bonded regions impart strength to the partition and make the panel cosmetically pleasing. The resulting partition has all of the advantages of prior art partitions made from plastic. It is sanitary, easy to clean and relatively graffiti proof. However, those partitions weigh considerably less than panels of the same size which are known in the prior art. We may also make these partitions using injection molding or vacuum molding techniques.

The process of forming or molding plastic partitions reduces the weight of the panels by decreasing the wall thickness and/or creating hollows. With a reduction in weight a single installer can now handle the panels during installation. For example, a solid plastic partition weighs two to four times that of our partition.

The forming or molding process decreases fabrication time. An example of a typical panel fabrication process for our partition is heat two sheets of resin, form them into a partition, cool the partition and then trim it. These steps can all be fully automated. An added benefit is that part quality is assured with dedicated tools and defined processes.

Partitions made in accordance with its present invention will be less expensive than prior art plastic partitions because less resin is used and labor costs will be low using a fully automated manufacturing process.

Besides the obvious cost decrease, a decrease in the volume of resin also benefits the environment. The formed or molded components can be fabricated from a recyclable resin. However, the less resin used the less the burden to recycle. With the thin wall or hollow nature of these formed components the resin reduction is two to four times that of their solid plastic counterparts.

Other objects and advantages of our bathroom partitions and method of making same will become apparent from a description of certain present preferred embodiments thereof which are shown in the drawings.

### BRIEF DESCRIPTION OF THE DRAWINGS

FIG. 1 is a perspective view of bathroom stalls defined by a present preferred embodiment of our partitions.

FIG. 2 is a perspective view of a portion of a second present preferred embodiment of our partitions.

FIG. 3 is an enlarged fragmentary view of the partition shown in FIG. 2.

FIGS. 4a through 4c are diagrams showing the process for thermoforming our partitions in which a third present preferred embodiment of our partition is shown.

### DESCRIPTION OF THE PREFERRED EMBODIMENTS

Bathrooms in public buildings and other locations often have several toilets and may have several urinals each mounted against a wall of the building. A partition is provided on either side of each toilet. These partitions are attached to the wall at one end and to a post at the opposite end. A door is hung from and between the posts. The door is usually made from the same type of fabrication process as is used for the partitions. Urinals are often separated by a partition attached to the wall between adjacent urinals. Similar partitions may be used in showers, dressing rooms and even desk cubicles.

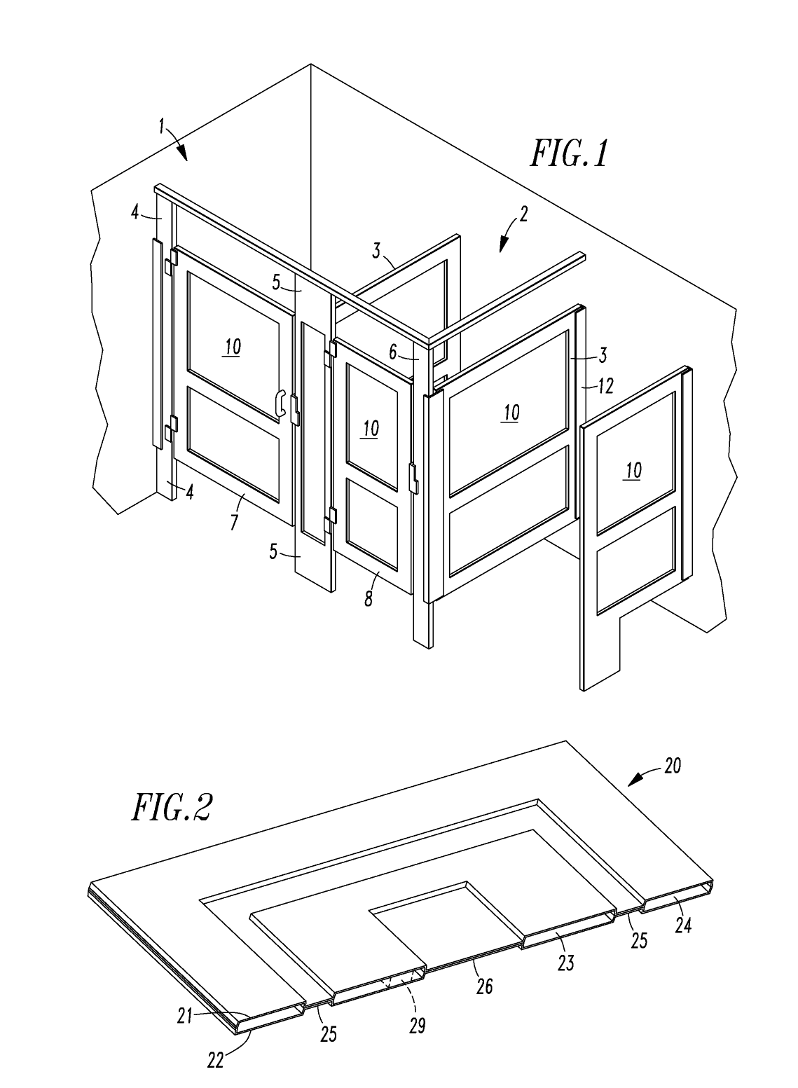

FIG. 1 illustrates a portion of a bathroom having two toilets and two urinals. Partitions and doors are provided to define two stalls 1 and 2. Partitions 3 extend from the wall on either side of the second stall. The first stall 1 is defined by a wall of the building and the partition 3 which is parallel to that wall. Posts 4, 5 and 6 are provided to carry the doors 7 and 8 for the stalls 1 and 2. The partitions and the doors are all made from panels 10 of similar construction made in accordance with the methods disclosed herein. Channels 12 are used to attach the panels 10 to the wall and posts.

A similar panel is also used for the partition 9 between the urinals. In the bathroom shown in FIG. 1 the panels are surrounded by trim 11. The trim may be a U-shaped channel that fits over the edge of the panel and can be made from plastic or metal. During installation of the partitions the installer may attach a channel to the wall for each partition using fasteners that pass through the base of the channel. Another channel can be attached to the post 5, 6 in a similar fashion. Then a third or bottom channel may be connected between these two channels. Next the panel 10 is slid into place covering the fasteners. Then a top channel may be placed on the panel. Should panel 10 become damaged the panel can easily be removed and replaced.

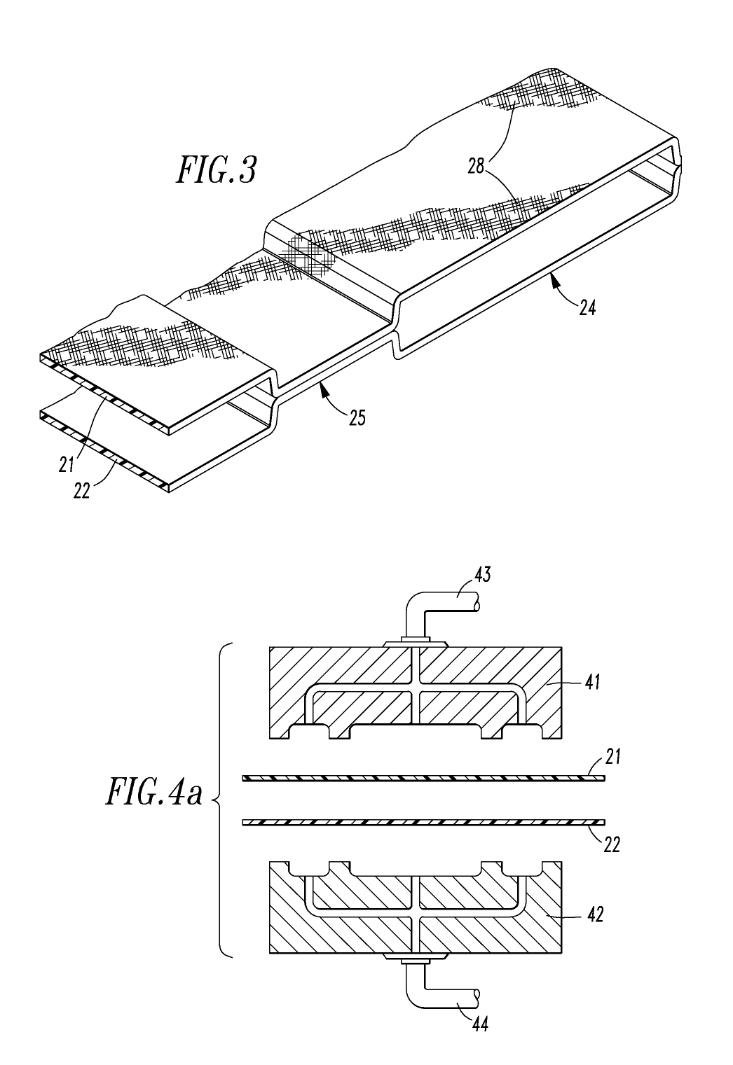

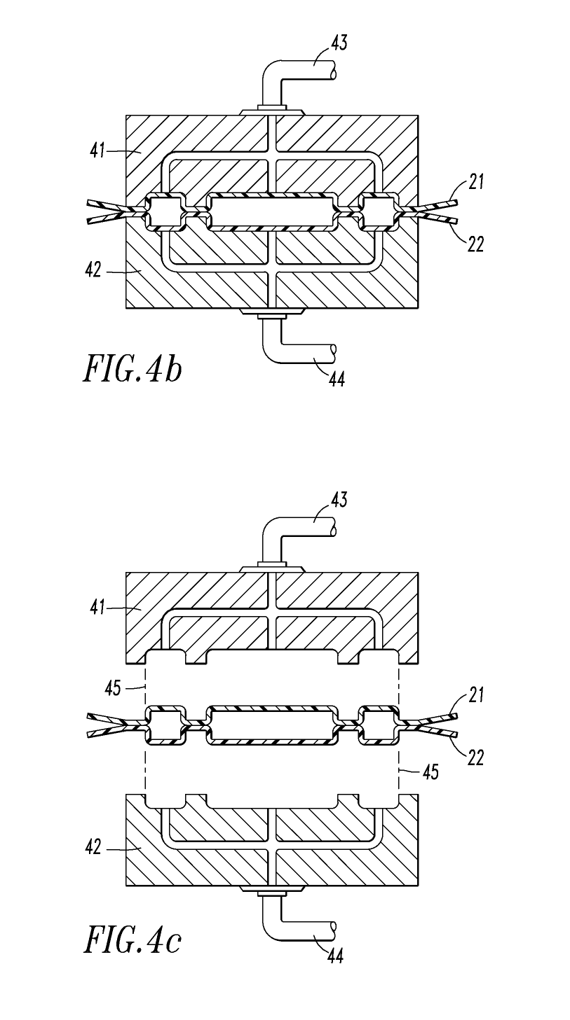

Our partition panels are preferably made from two sheets of plastic, as can be seen most clearly in the panel 20 shown in FIGS. 2 and 3. These panels can be made using a thermoforming process such as is illustrated in FIG. 4a through 4c. In the embodiment shown in FIGS. 2 and 3 sheets 21 and 22 have been thermoformed to provide bonded regions 23 and 24 where the sheets are spaced apart from one another and other hollow regions 25, 26 where the sheets abut one another and are bonded together. This configuration provides a combination of strength and light weight. In the partition panels 10 shown in FIG. 1 the center portion of the sheets abut and are bonded to one another while the outer portions of the sheets are spaced apart. In all of the embodiments the edges of the two sheets abut one another and are bonded together. The panels may have a pattern 28 embossed on the outer surface as shown in FIG. 3. The portion of the face of the partition panel which corresponds to regions where the sheets are bonded together may be quite small to provide the desired strength. Consequently, the size and configuration of the bonded regions may be primarily based upon aesthetic considerations.

For some applications the user may want to attach structures like the handles, toilet paper or other dispensers and handicap support bars to the partition. This can easily be done by drilling a hole in a hollow portion of the partition and using screw anchors for the screws. If desired we can place a support structure in the panel to provide a stronger attachment. The support structure may be a metal as hard plastic bar 29 shown in dotted lines in FIG. 2. The insert may be sized and positioned so that the structure is bonded to the partition during forming.

Our partition panels can be made with a thermoforming process such as is illustrated in FIGS. 4a through 4c. In this process, two sheets 21 and 22 of a plastic material are heated and placed between a top mold 41 and bottom mold 42. The top mold and bottom mold are closed together and a vacuum is drawn through pipes 43 and 44. This causes sheets 31 and 32 to be drawn against and conform to the inner surfaces of the molds as shown in FIG. 4b. When the molds are closed portions of the two sheets will abut one another at regions defined by the molds. Because the sheets have been heated and compressed they will bond together in these regions. After the partition panels are formed between the molds the edges of the panels are trimmed by a blade passing through planes indicated by broken lines 45 in FIG. 4c to remove any excess plastic or flashing. The heating and placement of the sheets between the molds, operations of the mold and trimming of the finished panels can all be automated. Depending upon the size of the panel and the configuration of the molds cycle time may range from about 2 minutes to about 10 minutes.

Although we prefer to use thermoforming to make our partitions, the product could be made by injection molding or vacuum molding. However, the molds required for these processes are likely to be much more expensive than thermoforming molds. Whatever process is used the resulting partition should be bonded, not open, around the entire perimeter of the panel. The panel should have at least one hollow region at least one solid region.

One advantage of thermoforming over metal panels and plastic lamination is that oil canning does not occur. Oil canning is a phenomenon that can occur in flat sheets of metal which are rolled or otherwise cold formed, in which waviness is seen in the flat surface. Residual stresses induced during forming can contribute to such wariness. Similar stress is not induced in plastic panels which are thermoformed.

We prefer to use high density polyethylene sheets to make the partition panels. However, other plastics suited for the thermoforming process or other molding process may be used. For example, many olefin materials or blends of olefin materials can be used. Low density polyethylene, polypropylene, thermoplastic polyolefins (TPO), acrylonitrile butadiene styrene (ABS) and co-polymers thereof may be suitable materials The sheets can be made in any desired color.

We further prefer to emboss the exterior surface of the sheets with a grain pattern. The grain pattern is not only attractive but is more difficult to mark with graffiti.

The sheets may be any desired thickness. However we prefer to use sheets which are ⅛ inches (0.3 cm.) thick. Partition panels made from sheets of this thickness may weight less then fifty pounds (22.68 kg).

Although we have disclosed certain present preferred embodiments of our partitions and methods of making them it should be distinctly understood that our invention is not limited thereto but may be variously embodied with the scope of the following claims.

We claim:

1. A partition panel comprised of two overlaying sheets of plastic material which have been bonded together around a perimeter and at selected regions of the sheets such that the partition contains bonded regions where the two sheets are bonded together and hollow regions where the two sheets are spaced apart from one another.

2. The partition panel of claim 1 also comprising a channel covering the perimeter.

3. The partition panel of claim 1 wherein the plastic material is a material selected from the group consisting of olefin materials, blends of olefin materials, low density polyethylene, polypropylene, thermoplastic polyolefins (TPO), acrylonitrile butadiene styrene (ABS) and co-polymers thereof.

4. The partition panel of claim 1 wherein the sheets are ⅛ inch thick.

5. The partition panel of claim 1 wherein the bathroom partition weighs less than 50 pounds.

6. The partition of claim 1 also comprising a fixture support within at least one of the hollow regions.

7. The partition of claim 1 wherein the two sheets have been thermoformed.

8. The partition panel of claim 1 wherein the partition panel has been formed by vacuum molding or injection molding.

9. A method of making a partition panel comprising:
placing two overlaying sheets of thermoplastic material in a thermoforming press having two opposing molds each mold having a plurality of complimentary recesses such that when the molds are closed the two sheets will be bonded together around a perimeter and at regions adjacent the recesses;
closing the molds and drawing a vacuum such that the two overlaying sheets are bonded together around a perimeter and at regions adjacent the recesses and the sheets are spaced apart at the recesses to form a partition;
separating the molds; and
removing the partition panel from the thermoforming press.

10. The method of claim 9 also comprising trimming any excess material from the perimeter.

11. The method of claim 9 also comprising placing a fixture support between the two sheets prior to closing the molds.

12. The method of claim 9 wherein the sheets have a thickness of ⅛ inch.

13. The method of claim 9 wherein the partition weighs less than 50 pounds.

14. The method of claim 9 also comprising applying a channel over the bonded perimeters of the partition panel.
